(19) United States
(12) Patent Application Publication
(10) Pub. No.: US 2003/0048298 A1
(43) Pub. Date: Mar. 13, 2003

(54) E-mail distribution with versatile address removal

(76) Inventor: Phyllis A. Ellendman, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 09/916,971

(22) Filed: Jul. 26, 2001

(51) Int. Cl. G06F 3/00; G06F 13/00

(52) U.S. Cl. 345/752

(57) ABSTRACT

One or more special fields are added to an e-mail message. The one or more special fields are used to specify addresses to be removed from address fields in preparation for sending the message. The special fields may include any combination of the following fields: a field used to specify addresses to be removed from a “To” field, a field used to specify addresses to be removed from a “Cc” field, a field used to specify addresses to be removed from a “Bcc” field, and a field used to specify addresses to be removed from all address fields.

### BACKGROUND

The present invention pertains to communication via electronic mail (e-mail) and pertains particularly to e-mail distribution with versatile address removal.

Electronic mail has proven to be a convenient and efficient method of communication. A single message can have an unlimited number of addressees to whom the message is sent, copied or blind copied. A plethora of software packages are used for e-mail. For typical e-mail functionality, see for example, the Microsoft Entourage software package available from Microsoft Corporation.

While adding addresses and combining lists when addressing an outgoing message is easily accomplished, it is less convenient to target a single address or a list subset to be removed from an e-mail group list for a particular mailing.

### SUMMARY OF THE INVENTION

In accordance with the preferred embodiment of the present invention, one or more special fields are added to an e-mail message. The one or more special fields are used to specify addresses to be removed from address fields in preparation for sending the message. The special fields may include any combination of the following fields: a field used to specify addresses to be removed from a “To” field, a field used to specify addresses to be removed from a “Cc” field, a field used to specify addresses to be removed from a “Bcc” field, and a field used to specify addresses to be removed from all address fields.

The present invention is particularly useful for allowing one or more addresses to be removed from a group list in an address field. The addresses to be removed can be specified individually and/or as part of a group list placed in one of the special fields.

### BRIEF DESCRIPTION OF THE DRAWINGS

FIG. 1 is a simplified display of an outgoing e-mail message.

FIG. 2 is a simplified display of address fields and special fields for an outgoing e-mail message in accordance with a preferred embodiment of the present invention.

FIG. 3 is a simplified flowchart that illustrates addresses being removed from a “To” list address field of an outgoing e-mail message in accordance with a preferred embodiment of the present invention.

FIG. 4 is a simplified flowchart that illustrates addresses being removed from a carbon copy “Cc” list address field of an outgoing e-mail message in accordance with a preferred embodiment of the present invention.

FIG. 5 is a simplified flowchart that illustrates addresses being removed from a blind carbon copy “Bcc” list address field of an outgoing e-mail message in accordance with a preferred embodiment of the present invention.

FIG. 6 is a simplified display of address fields and a special field for an outgoing e-mail message in accordance with an alternative preferred embodiment of the present invention.

### DESCRIPTION OF THE PREFERRED EMBODIMENT

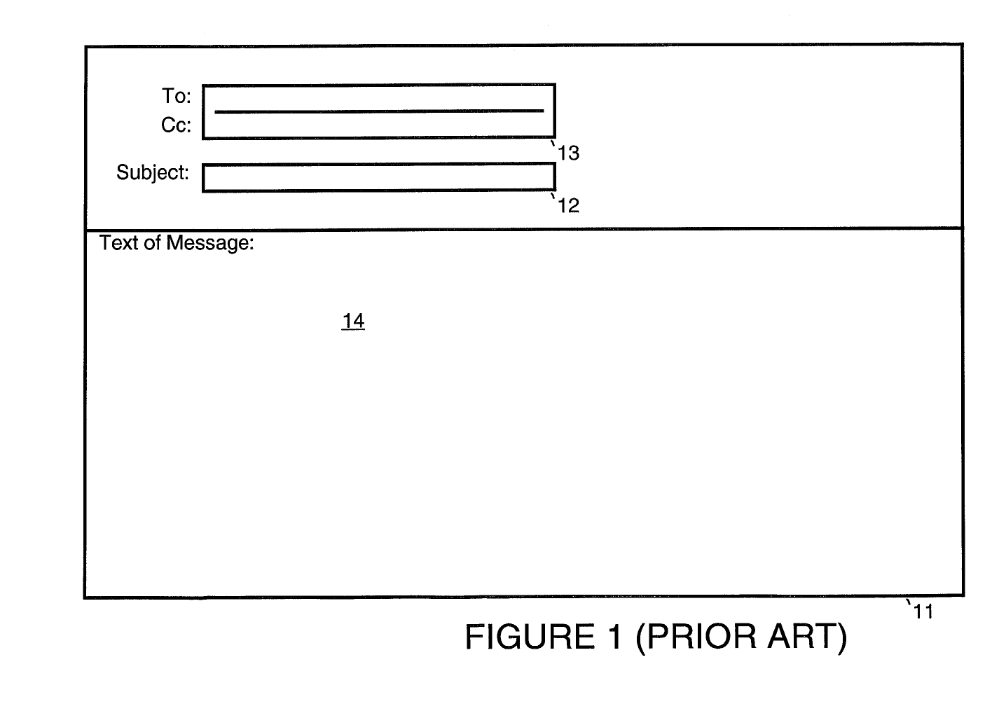

FIG. 1 is a simplified display of an outgoing e-mail message 11. An address field 13 displays “To” addresses and “Cc” addresses. A subject field 12 lists a subject for e-mail message 11. A text section 14 contains a text for e-mail message 11.

Address field 13 is selected, for example, by using a pointing device to place a cursor over address field 13 and then double clicking on a selection button of the pointing device. As a result of the selection, a display of the full address fields for e-mail message 11 is shown.

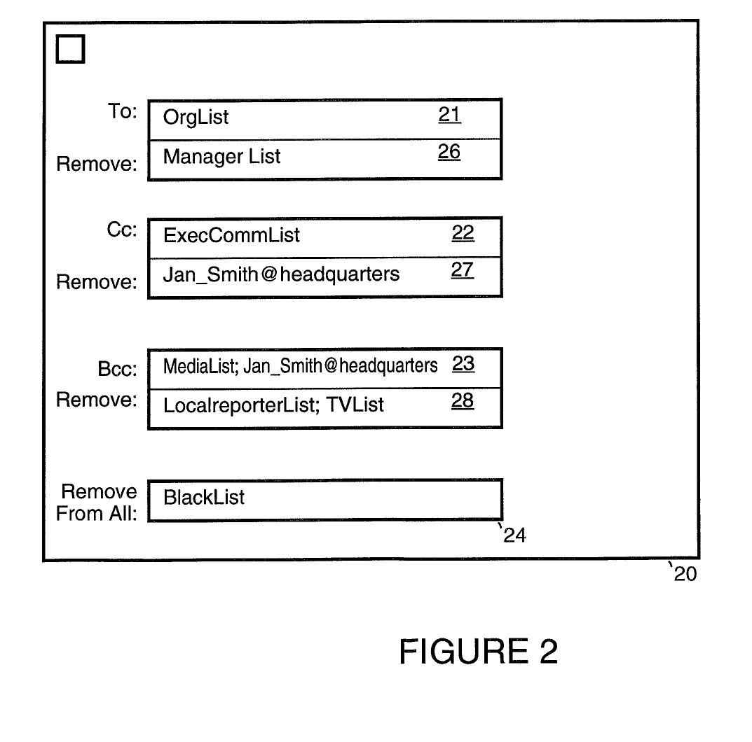

FIG. 2 shows a display of the full address fields for e-mail message 11. Particularly, in FIG. 2, an address field 21 is for “To” addresses. An address field 22 is for “Cc” addresses. An address field 23 is for “Bcc” addresses. An address field 24 is used to list e-mail addresses to be removed from the “To” addresses, “Cc” addresses and the “Bcc” addresses.

Address field 21 lists “To” addresses and has an associated “Remove” field 26. Remove field 26 lists addresses to be removed from the “To” addresses before an e-mail message is sent.

For example, OrgList is a mail group list that includes the addresses listed in Table 1 below:

TABLE I

Charles
Angie
Sally
Nalini
Anna
John
James
Tammy
Mark
John
Michael
Victoria
Meredith
Martin
Jon
Kenneth
Dennis
Randall
William
Shane
James
Thomas
Daniel
David
Kenneth

For example, Manager List is a mail group list that includes the addresses listed in Table 2 below:

TABLE 2

Angie
Nalini
Anna
James
Mark
John
Victoria
Meredith
Martin
Kenneth
Dennis
Randall
Shane
James
Daniel
Kenneth

While Manager List is the only listing in special (“Remove”) field 26, additional lists and/or individual addresses can be listed in “Remove” field 26. This is true for all address fields and special fields shown in FIG. 2.

When sending e-mail message 11, the addresses Angie, Nalini, Anna, James, Mark, John, Victoria, Meredith, Martin, Kenneth, Dennis, Randall, Shane, James, Daniel and Kenneth are removed from the “To” addresses before e-mail message 11 is sent. The resulting addresses to whom e-mail message 11 are to be sent as a “To” addressee are Charles, Sally, Tammy Michael, Martin, Jon, William Thomas and David.

Address field 22 lists “Cc” addresses and has an associated “Remove” field 27. Remove field 27 lists addresses to be removed from the “To” addresses before a message is sent.

For example, ExecCommList is a mail group list that includes the following addresses: Mark_Smith@headquarters, Janis_James@headquarters, Jan_Smith@headquarters, Marily_Jones@headquarters and Edgar_Allen@headquarters.

Remove field 27 lists a single address to be removed from the “Cc” addresses before a message is sent. The single address is Jan_Smith@headquarters.

When sending e-mail message 11, the address Jan_Smith@headquarters is removed from the “Cc” addresses before e-mail message 11 is sent. The resulting addresses to whom e-mail message 11 is sent as a “Cc” addressee are Mark_Smith@headquarters, Janis_James@headquarters, Marily_Jones@headquarters and Edgar_Allen@headquarters.

Address field 23 lists “Bcc” addresses and has an associated “Remove” field 28. Remove field 28 lists addresses to be removed from the “Bcc” addresses before an e-mail message is sent.

For example, MediaList is a mail group list that includes the following addresses: joe@localpaper, albert@localpaper, don@localpaper, rowena@radiostation, valorie@radiostation, margorie@tvstation, henry@televisionstation, maggie@nationalpaper and Arnold@nationalpaper.

LocalreporterList is a mail group list that includes the following addresses: joe@localpaper, albert@localpaper and don@localpaper.

TVList is a mail group list that includes the following addresses: margorie@tvstation and henry@televisionstation.

When sending e-mail message 11, the addresses joe@localpaper, albert@localpaper and don@localpaper, margorie@tvstation and henry@televisionstation are removed from the “Bcc” addresses before e-mail message 11 is sent. The resulting addresses to whom e-mail message 11 is sent as a “Bcc” addressee are rowena@radiostation, valorie@radiostation, maggie@nationalpaper, arnold@nationalpaper and Jan_Smith@headquarters.

An additional address field lists addresses to be removed the “To” list, the “Cc” list and the “Bcc” list. For example, BlackList is a mail group list that includes the following addresses: rowena@radiostation, Jennifer, David and Brian. When sending e-mail message 11, a search is done to see if any of these addresses exist in the “To” list, the “Cc” list and the “Bcc” list. If so, these names are removed. For example, in e-mail message 11, rowena@radiostation is removed from the “Bcc” list. David is removed from the “To” list. Jennifer and Brian do not appear as an addressee in e-mail message 11, so these addresses are ignored.

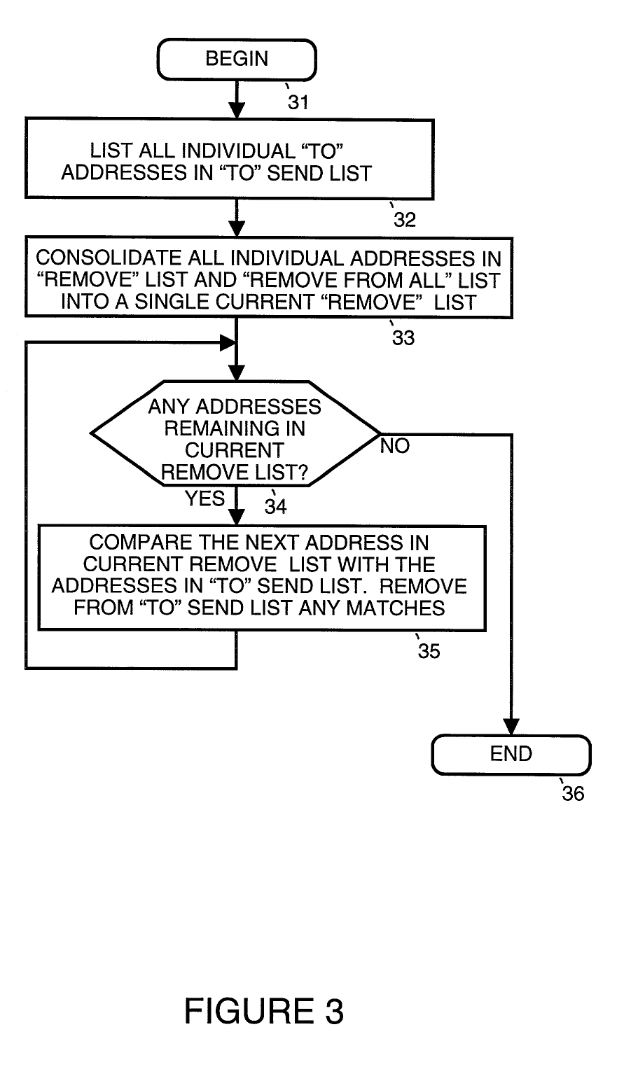

FIG. 3 is a simplified flowchart that illustrates addresses being removed from a “To” list address field of an outgoing e-mail message. As illustrated by a step 31, upon sending an outgoing message this process is performed. In a step 32, all the addresses in the “To” field are placed in a “To” send list. This is done by adding addresses within any group lists listed in the “To” field to any individual addresses listed in the “To” field.

In a step 33, all the addresses in the “Remove” field associated with the “To” field and in the “Remove from all” field are consolidated in a current “Remove” send list. This is done by adding addresses within any group lists listed in the “Remove” field of the “To” field and the “Remove from all” field to any individual addresses listed in the “Remove” field of the “To” field and the “Remove from all” field. Duplicates are eliminated.

In a step 34, a determination is made as to whether there are any addresses in the current remove list which have not yet been used to search the “To” send list. If so, in a step 35, a next address in the current remove list is compared to addresses in the “To” send list. Any matching address is removed from the “To” send list. Steps 34 and 35 are repeated until there are no longer any addresses in the current remove list which have not yet been used to search the “To” send list. When there are no longer any addresses in the current remove list which have not yet been used to search the “To” send list, in a step 36, the process of removing addresses from the “To” field is completed and the “To” send list contains the final “To” addresses for the e-mail message.

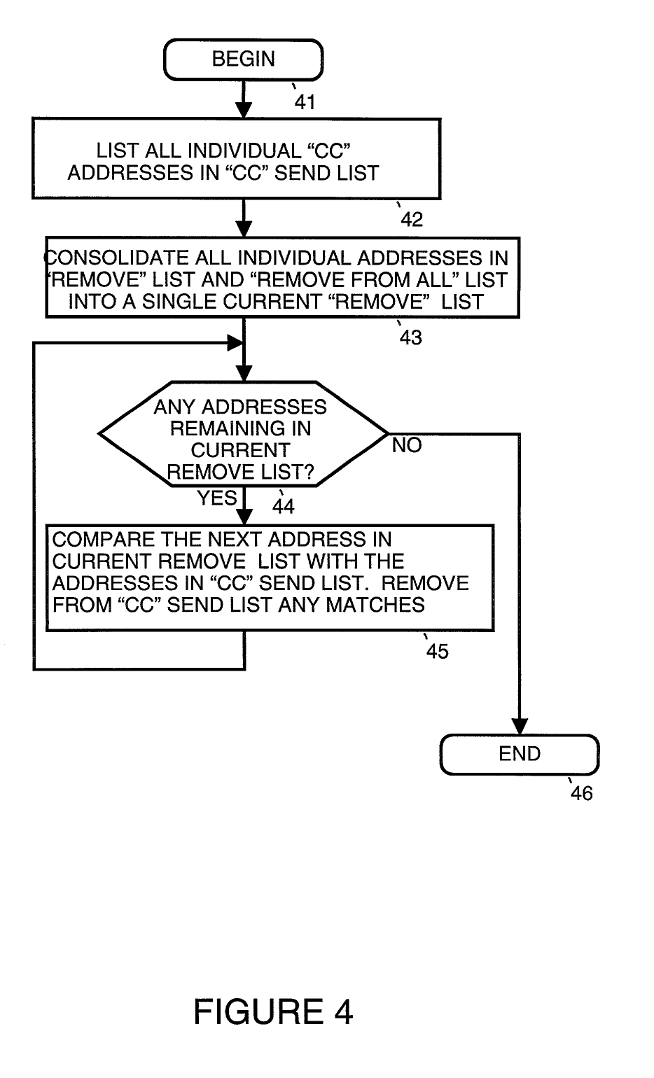

FIG. 4 is a simplified flowchart that illustrates addresses being removed from a “Cc” list address field of an outgoing e-mail message. As illustrated by a step 41, upon sending an outgoing message this process is performed. In a step 42, all the addresses in the “Cc” field are placed in a “Cc” send list. This is done by adding addresses within any group lists listed in the “Cc” field to any individual addresses listed in the “Cc” field.

In a step 43, all the addresses in the “Remove” field associated with the “Cc” field and in the “Remove from all” field are consolidated in a current “Remove” send list. This is done by adding addresses within any group lists listed in the “Remove” field of the “Cc” field and the “Remove from all” field to any individual addresses listed in the “Remove” field of the “Cc” field and the “Remove from all” field. Duplicates are eliminated.

In a step 44, a determination is made as to whether there are any addresses in the current remove list which have not yet been used to search the “Cc” send list. If so, in a step 45, a next address in the current remove list is compared to addresses in the “Cc” send list. Any matching address is removed from the “Cc” send list. Steps 44 and 45 are repeated until there are no longer any addresses in the current remove list which have not yet been used to search the “Cc” send list. When there are no longer any addresses in the current remove list which have not yet been used to search the “Cc” send list, in a step 46, the process of removing addresses from the “Cc” field is completed and the “Cc” send list contains the final “Cc” addresses for the e-mail message.

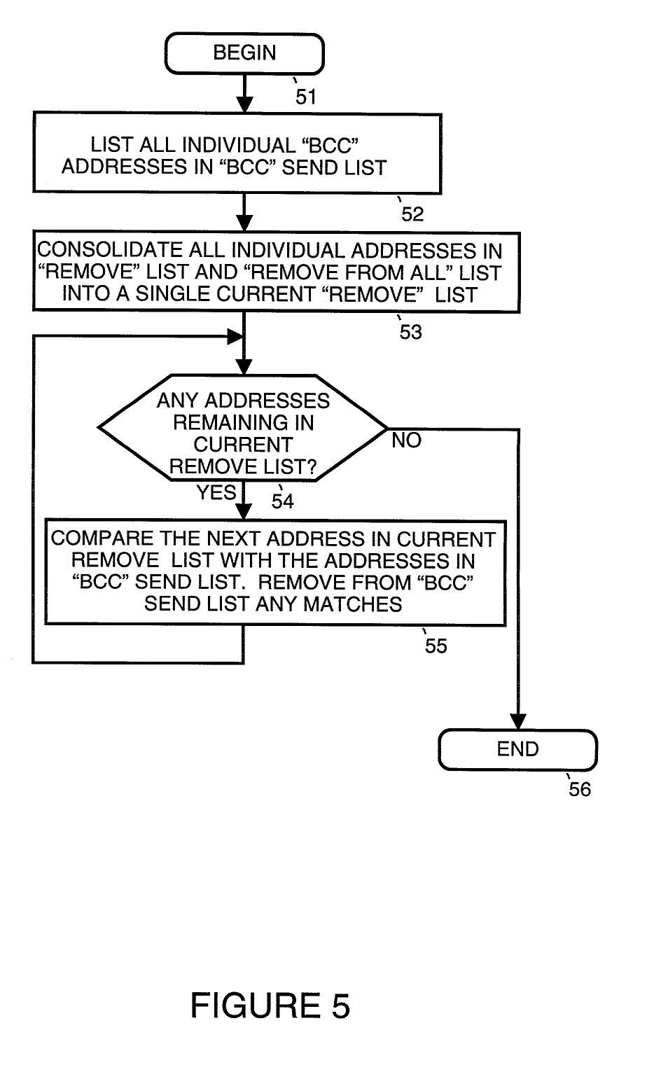

FIG. 5 is a simplified flowchart that illustrates addresses being removed from a “Bcc” list address field of an outgoing e-mail message. As illustrated by a step 51, upon sending an outgoing message this process is performed. In a step 52, all the addresses in the “Bcc” field are placed in a “Bcc” send list. This is done by adding addresses within any group lists listed in the “Bcc” field to any individual addresses listed in the “Bcc” field.

In a step 53, all the addresses in the “Remove” field associated with the “Bcc” field and in the “Remove from all” field are consolidated in a current “Remove” send list. This is done by adding addresses within any group lists listed in the “Remove” field of the “Bcc” field and the “Remove from all” field to any individual addresses listed in the “Remove” field of the “Bcc” field and the “Remove from all” field. Duplicates are eliminated.

In a step 54, a determination is made as to whether there are any addresses in the current remove list which have not yet been used to search the “Bcc” send list. If so, in a step 55, a next address in the current remove list is compared to addresses in the “Bcc” send list. Any matching address is removed from the “Bcc” send list. Steps 54 and 55 are repeated until there are no longer any addresses in the current remove list which have not yet been used to search the “Bcc” send list. When there are no longer any addresses in the current remove list which have not yet been used to search the “Bcc” send list, in a step 56, the process of removing addresses from the “Bcc” field is completed and the “Bcc” send list contains the final “Bcc” addresses for the e-mail message.

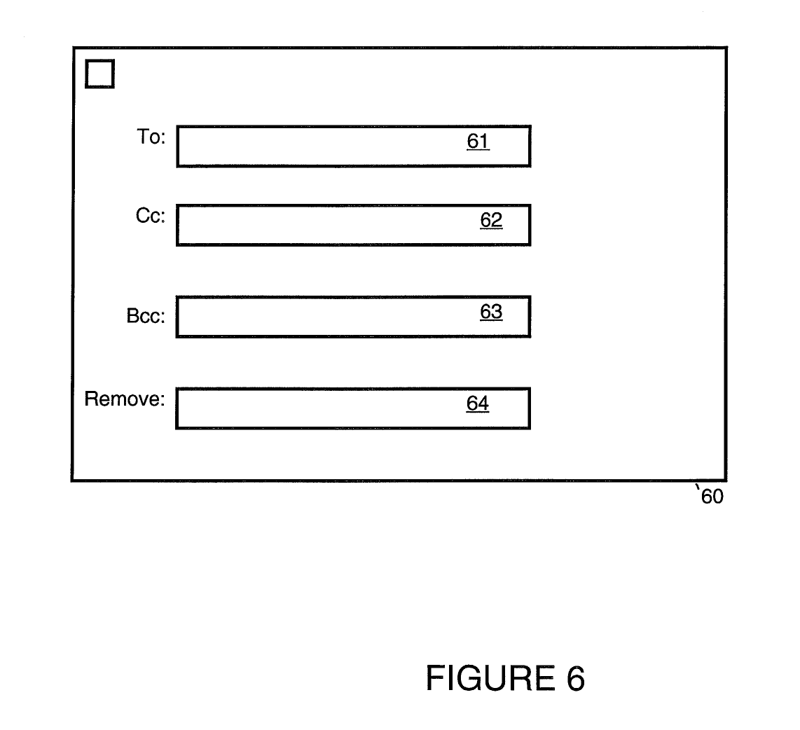

FIG. 6 shows a display of the full address fields for an alternative embodiment of e-mail message 11. Particularly, in FIG. 6, an address field 61 is for “To” addresses. An address field 62 is for “Cc” addresses. An address field 63 is for “Bcc” addresses. An address field 64 is used to list e-mail addresses to be removed from the “To” addresses, “Cc” addresses and the “Bcc” addresses. There are no additional “Remove” fields.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

I claim:

1. A method for sending an electronic message comprising the following steps:
(a) in preparation for sending an e-mail message, performing the following substep:
(a.1) removing from any addresses specified in a “To” field, any addresses within a field used to specify addresses to be removed from the “To” field; and,
(b) sending the e-mail message.

2. A method as in claim 1 wherein step (a) additionally comprises the following substep:
(a.2) removing from any addresses specified in a “Cc” field, any addresses within a field used to specify addresses to be removed from the “Cc” field.

3. A method as in claim 1 wherein step (a) additionally comprises the following substep:
(a.2) removing from any addresses specified in a “Bcc” field, any addresses within a field used to specify addresses to be removed from the “Bcc” field.

4. A method as in claim 1 wherein in substep (a.1) at least a subset of addresses to be removed from the “To” field are specified using a group list.

5. A method as in claim 1 wherein in substep (a.1) at least a subset of addresses to be removed from the “To” field are specified using at least one group list and at least one individually listed address.

6. A method as in claim 1 wherein step (a) additionally comprises the following substep:
(a.2) removing from any addresses specified in the “To” field, any addresses within a field used to specify addresses to be removed from all address fields.

7. A method as in claim 1 wherein step (a) additionally comprises the following substeps:
(a.2) removing from any addresses specified in a “Cc” field, any addresses within a field used to specify addresses to be removed from the “Cc” field;
(a.3) removing from any addresses specified in a “Bcc” field, any addresses within a field used to specify addresses to be removed from the “Bcc” field; and,
(a.4) removing from any addresses specified in the “To” field, the “Cc” field and the “Bcc” field any addresses within a field used to specify addresses to be removed from all address fields.

8. A method for sending an electronic message comprising the following steps:
(a) in preparation for sending an e-mail message, performing the following substep:
(a.1) removing from any addresses specified in a “To” field, a “Cc” field and a “Bcc” field of the e-mail message any addresses within a field used to specify addresses to be removed from all address fields.
(b) sending the e-mail message.

9. An electronic mail system for generating a message for being sent electronically, the message comprising the following fields:
a “To” field for listing primary addresses to receive the message; and,
a field used to specify addresses to be removed from the “To” field in preparation for sending the message.

10. An electronic mail system as in claim 9, the message additionally comprising the following fields:
a “Cc” field for listing addresses to receive a copy of the message; and, a field used to specify addresses to be removed from the “Cc” field in preparation for sending the message.

11. An electronic mail system as in claim 9, the message additionally comprising the following fields:
a “Bcc” field for listing addresses to receive a blind copy of the message; and,
a field used to specify addresses to be removed from the “Bcc” field in preparation for sending the message.

12. An electronic mail system as in claim 9, the message additionally comprising the following field:
a field used to specify addresses to be removed from all address fields in preparation for sending the message.

13. An electronic mail system as in claim 9, the message additionally comprising the following fields:
a “Cc” field for listing addresses to receive a copy of the message;
a “Bcc” field for listing addresses to receive a blind copy of the message; and,
a field used to specify addresses to be removed from all address fields in preparation for sending the message.

14. An electronic mail system for generating a message for being sent electronically, the message comprising the following fields:
a “To” field for listing primary addresses to receive the message;
a “Cc” field for listing addresses to receive a copy of the message;
a “Bcc” field for listing addresses to receive a blind copy of the message; and,
a field used to specify addresses to be removed from all address fields in preparation for sending the message.
